(19) United States
(12) Patent Application Publication
(10) Pub. No.: US 2012/0329975 A1
(43) Pub. Date: Dec. 27, 2012

(54) METHOD FOR PRODUCING LIQUID CRYSTAL POLYESTER

(75) Inventors: Tomoya HOSODA, Tsukuba-shi (JP); Eiji HOSODA, Niihama-shi (JP); Masanobu MATSUBARA, Niihama-shi (JP)

(73) Assignee: Sumitomo Chemical Company, Limited, Tokyo (JP)

(21) Appl. No.: 13/488,935

(22) Filed: Jun. 5, 2012

(30) Foreign Application Priority Data
Jun. 27, 2011 (JP) 2011-142150

(51) Int. Cl. C08G 63/87

(52) U.S. Cl. 528/182

(57) ABSTRACT

Disclosed is a method for producing a liquid crystal polyester, which includes the following steps of:
(1) melt-polycondensing a compound as a monomer in a polymerization tank to produce a prepolymer;
(2) discharging the prepolymer from the polymerization tank in a molten state, and solidifying the prepolymer through cooling to produce a sheet in which a portion having a thickness of 1.6 to 2 mm accounts for 80% by mass or more (of 100% by mass of the entire sheet);
(3) crushing the sheet; and
(4) subjecting the crushed product to solid-phase polymerization through heating.

### BACKGROUND OF THE INVENTION

1. Field of the Invention

The present invention relates a method for producing a liquid crystal polyester.

2. Description of the Related Art

JP-A-2001-72750 (corresponding application is US2003-0088053A) discloses, as a method for producing a liquid crystal polyester having a high molecular weight with satisfactory productivity, a method for producing a liquid crystal polyester comprising the steps of (1) polycondensing a monomer in a reaction vessel within a short time, (2) discharging the formed polymer in a molten state where the formed polymer can be easily discharged from the reaction vessel, and solidifying the polymer, and (3) subjecting the solidified polymer to solid-phase polymerization thereby increasing the molecular weight. It is also studied that heat transfer efficiency of the polymer is increased by crushing the polymer solidified in the step (2), and thus facilitating control of the polymerization degree in the step (3) and shortage of the polymerization time. For example, it is studied to facilitate crushing of the polymer by forming the polymer into a sheet through solidification (see, for example, JP-A-06-256485, JP-A-02-86412 (corresponding application is U.S. Pat. No. 5,015,723) and JP-A-2002-179779).

However, any production methods mentioned above are unsatisfactory from the viewpoint of improving productivity by shortening the production time (polymerization time) of a liquid crystal polyester.

### SUMMARY OF THE INVENTION

An object of the present invention is to provide a method for producing a liquid crystal polyester, with productivity improved by controlling bulk density of a crushed product used in solid-phase polymerization.

The present invention provides a method for producing a liquid crystal polyester comprising the following steps of:
(1) melt-polycondensing a compound as a monomer in a polymerization tank to produce a prepolymer;
(2) discharging the prepolymer from the polymerization tank in a molten state, and solidifying the prepolymer through cooling to produce a sheet in which a portion having a thickness of 1.6 to 2 mm accounts for 80% by mass or more (of 100% by mass of the entire sheet);
(3) crushing the sheet; and
(4) subjecting the crushed product to solid-phase polymerization through heating.

According to the present invention, it is possible to provide a method for producing a liquid crystal polyester, with improved productivity.

### BRIEF DESCRIPTION OF THE DRAWINGS

FIG. 1 is a schematic view showing an example of an apparatus for producing a liquid crystal polyester according to the present invention; and

FIG. 2 is a view showing a prepolymer solidified by a cooling apparatus 20 of FIG. 1.

### DETAILED DESCRIPTION OF THE INVENTION

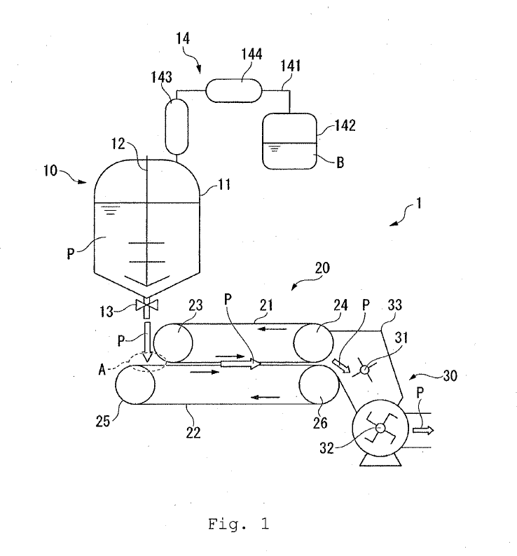

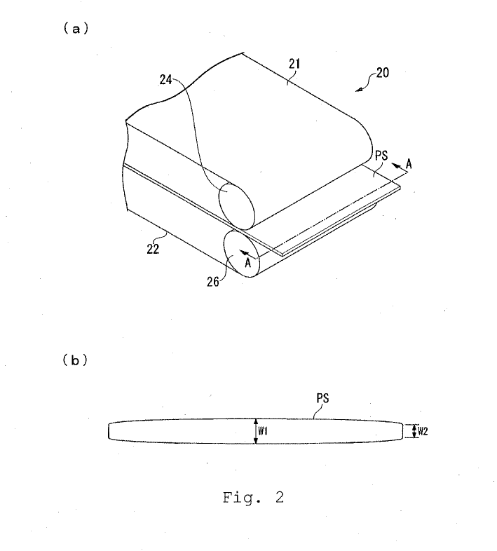

The present invention will be described below with reference to FIGS. 1 and 2. The size and proportion of each component are not necessarily the same as actual size and proportion for simplicity of the drawing.

In FIG. 1, a production apparatus 1 includes polymerization apparatus 10 for producing a prepolymer P, a cooling apparatus 20 for transferring the prepolymer P discharged from the polymerization apparatus 10 in a horizontal direction while solidifying the prepolymer with cooling, and a crushing apparatus 30 for crushing the solidified prepolymer P. The prepolymer P crushed by the crushing apparatus 30 is transferred to a solid-phase polymerization facility (not shown), where the prepolymer is subjected to solid-phase polymerization. Namely, the above step (1) is performed in the polymerization apparatus 10, the above step (2) is performed in the cooling apparatus 20, the above step (3) is performed in the crushing apparatus 30, and the above step (4) is performed in the solid-phase polymerization facility (not shown).

Typical examples of the liquid crystal polyester produced by the production method of the present invention include:

(I) a liquid crystal polyester obtained by polycondensing an aromatic hydroxycarboxylic acid, an aromatic dicarboxylic acid and/or an aromatic diol;

(II) a liquid crystal polyester obtained by polycondensing plural kinds of aromatic dicarboxylic acids; and

(III) a liquid crystal polyester obtained by polymerizing a polyester such as polyethylene terephthalate with an aromatic hydroxycarboxylic acid.

Herein, a part or all of an aromatic hydroxycarboxylic acid, an aromatic dicarboxylic acid and an aromatic diol may be changed, respectively independently, to a polymerizable derivative thereof.

Examples of the polymerizable derivative of the compound having a carboxyl group such as an aromatic hydroxycarboxylic acid and an aromatic dicarboxylic acid include a derivative (ester) in which a carboxyl group is converted into an alkoxycarbonyl group or an aryloxycarbonyl group; a derivative (acid halide) in which a carboxyl group is converted into a haloformyl group, and a derivative (acid anhydride) in which a carboxyl group is converted into an acyloxycarbonyl group.

Examples of the polymerizable derivative of the compound having a phenolic hydroxyl group such as an aromatic hydroxycarboxylic acid or an aromatic diol include a derivative (acylate) in which a phenolic hydroxyl group is converted into an acyloxyl group by acylation.

The polymerization apparatus 10 shown in FIG. 1 includes a polymerization tank 11, a stirrer 12 provided in the polymerization tank 11, and a valve 13 for controlling a discharge amount of a prepolymer, provided at the lower portion of the polymerization tank 11. A recovery apparatus 14 for recovering by distilling off a substance containing a by-product B formed in the step (1) is provided at the upper portion of the polymerization tank 11. The recovery apparatus 14 includes a piping 141, one end of which is connected to the polymerization tank 11, and a tank 142 to which the other end of the piping 141 is connected. In the piping 141, a first cooler 143 and a second cooling 144, for cooling the by-product B evaporated from the polymerization tank 11 side, are provided.

A prepolymer P is produced by stirring a monomer for the production of a liquid crystal polyester under heating in the polymerization tank 11 of the polymerization apparatus 10, followed by polycondensation (melt polycondensation) in a molten state.

The monomer for the production of a liquid crystal polyester is preferably a monomer represented by the following formula (1′) (hereinafter referred to as “monomer (1′)”), and more preferably a combination of the monomer (1′), a monomer represented by the following formula (2′) (hereinafter referred to as a “monomer (2′)”) and a monomer represented by the following formula (3′) (hereinafter referred to as a “monomer (3′)”):

G¹-O—Ar¹—CO-G², (1′)

G²-CO—Ar²—CO-G², and (2′)

G¹-O—r³—O-G¹ (3′)

wherein Ar¹ is a 2,6-naphthylene group, a 1,4-phenylene group or a 4,4′-biphenylylene group; Ar² and Ar³ each independently represents a 2,6-naphthylene group, a 1,4-phenylene group, a 1,3-phenylene group or a 4,4′-biphenylylene group; three G¹(s) each independently represents a hydrogen atom or an alkylcarbonyl group; three G²(s) each independently represents a hydroxyl group, an alkoxy group, an aryloxy group, an alkylcarbonyloxy group or a halogen atom; and one or more hydrogen atoms in Ar¹, Ar² and Ar³ each independently may be substituted with a halogen atom, an alkyl group or an aryl group.

Examples of the, halogen atom, with which one or more hydrogen atoms in Ar¹, Ar² and Ar³ are substituted, include a fluorine atom, a chlorine atom, a bromine atom and an iodine atom.

Examples of the alkyl group, with which one or more hydrogen atoms in Ar¹, Ar² and Ar³ are substituted, include a methyl group, an ethyl group, an n-propyl group, an isopropyl group, an n-butyl group, an isobutyl group, a sec-butyl group, a tert-butyl group, an n-pentyl group, an n-hexyl group, an n-heptyl group, a 2-ethylhexyl group, an n-octyl group, an n-nonyl group and an n-decyl group, each preferably having 1 to 10 carbon atoms.

Examples of the aryl group, with which one or more hydrogen atoms in Ar¹, Ar² and Ar³ are substituted, include a phenyl group, an o-tolyl group, a m-tolyl group, a p-tolyl group, a 1-naphthyl group and a 2-naphthyl group, each preferably having 6 to 20 carbon atoms.

In case the hydrogen atom is substituted with these groups, the number of the groups is preferably 2 or less, and more preferably 1, each independently, every group represented by Ar¹, Ar² or Ar³.

Examples of the alkylcarbonyl group of G¹ include the above-mentioned monovalent groups in which an alkyl group is combined to a carbonyl group (—C(═O)—) such as methylcarbonyl group (acetyl group) and an ethylcarbonyl group.

Examples of the alkoxy group of G² include the above-mentioned monovalent groups in which an alkyl group is combined to oxygen atoms (—O—) such as a methoxy group and an ethoxy group.

Examples of the aryloxy group of G² include the above-mentioned monovalent groups in which an aryl group is combined to oxygen atoms (—O—) such as a phenoxy group.

Examples of the alkylcarbonyloxy group of G² include the above-mentioned monovalent groups in which an alkyl group is combined to carbon atoms of a carbonyloxy group (—C(═0)—O—) such as a methylcarbonyloxy group and an ethylcarbonyloxy group.

Examples of the halogen atom of G² include a chlorine atom, a bromine atom and an iodine atom.

In case the monomer is a compound having a phenolic hydroxyl group such as a compound of the above formula (1′) in which G¹ is a hydrogen atom, or a compound of the above formula (3′) in which one or two G¹ is/are hydrogen atom(s), a conversion ratio in the step (1) is less likely to increase in some cases since these compounds have low polycondensation reactivity. In order to increase the conversion ratio, the phenolic hydroxyl group-containing compound is preferably polycondensated after converting into an acylated compound having high polycondensation reactivity in the polymerization apparatus of the step (1) using a fatty acid anhydride from the viewpoint of simplicity of the operation. Acylation may be performed in a separate reaction vessel of the polymerization apparatus.

In the present invention, the monomer of the above formula (1′) in which G¹ is a hydrogen atom and/or the monomer of the above formula (3′) in which G¹ is a hydrogen atom is/are preferably acylated before melt polycondensation of the step (1).

There is no particular limitation on the fatty acid anhydride. Examples of the fatty acid anhydride include acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride; and two or more combinations thereof. Among these fatty acid anhydrides, acetic anhydride, propionic anhydride, butyric anhydride or isobutyric anhydride is preferable and acetic anhydride is more preferable from the viewpoint of costs and handling properties.

The use amount of the fatty acid anhydride is preferably from 1.00 to 1.20 equivalents based on 1 equivalent of the phenolic hydroxyl group. The use amount of the fatty acid anhydride is more preferably from 1.00 to 1.05 equivalents, and still more preferably from 1.03 to 1.05 equivalents from the viewpoint of less outgassing from a molded article and performances such as solder blister resistance of a molded article. From the viewpoint of impact strength of a molded article, the use amount is more preferably from 1.05 to 1.10 equivalents.

When the use amount of the fatty acid anhydride is less than 1.00 equivalent, equilibrium of the acylation reaction shifts to the fatty acid anhydride side. As a result, sublimation of the aromatic diol and/or aromatic dicarboxylic acid, which is/are not acylated, may cause clogging of the polymerization apparatus of the step (1). When the use amount of the fatty acid anhydride is more than 1.20 equivalents, the obtained liquid crystalline polyester may cause severe coloration.

The acylation reaction is preferably performed under the conditions at 130 to 180° C. for 30 minutes to 20 hours, and more preferably 140 to 160° C. for 1 to 5 hours.

Examples of the material of the reaction vessel for performing the acylation reaction include materials having corrosion resistance such as titanium and hastelloy B. When the objective liquid crystal polyester requires high color tone (L value), the material of the inner wall of the reaction vessel is preferably glass. Examples of the reaction vessel in which the material of an inner wall is glass include a reaction vessel which is entirely made of glass, a reaction vessel in which only an inner wall of the portion in contact with the reaction mixture is made of a glass, and a reaction vessel made of SUS whose inner wall is glass-lined. Among these reaction vessels, a reaction vessel whose inner wall is glass-lined is preferable in a large-sized production facility.

The use amount of the monomer (1′) in the step (1) is preferably 30 mol % or more, more preferably from 30 to 80 mol %,, still more preferably from 40 to 70 mol %, and particularly preferably from 45 to 65 mol % based on 100 mol % in the total use amount of the monomers (1′), (2′) and (3′). When the use amount is 30 mol % or more, heat resistance, strength and rigidity of the obtained liquid crystal polyester are likely to be improved. When the use amount is more than 65 mol %, the solubility of the obtained liquid crystal polyester in a solvent is likely to decrease. Each use amount of the monomers (2′) and (3′) is preferably 35 mol % or less, more preferably from 10 to 35 mol %, still more preferably from 15 to 30 mol %, and particularly preferably from 17.5 to 27.5 mol %.

The use amount of the monomer in which Ar¹, Ar² or Ar³ is a 2,6-naphthylene group is preferably 10 mol % or more, and more preferably 40 mol % or more, based on 100 mol % in the total use amount of the monomers (1′), (2′) and (3′).

A ratio of the use amount (mol) of the monomer (2′) to that of the monomer (3′), namely [use amount of the monomer (2′)]/[use amount of the monomer (3′)], is preferably from 0.9/1 to 1/0.9, more preferably from 0.95/1 to 1/0.95, and still more preferably from 0.98/1 to 1/0.98.

The monomers (1′) to (3′) may be used alone, or two or more kinds of compounds may be used in combination. In the step (1), monomers other than the monomers (1′) to (3′) may be used. The use amount of other monomers is preferably 10 mol % or less, and more preferably 5 mol % or less, based on 100 mol % in the total use amount of all monomers in the step (1).

The step (1) may be performed in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among these catalysts, nitrogen-containing heterocyclic compounds are preferable. Use of the catalyst and kind of the catalyst when used may be determined according to applications of the liquid crystal polyester. For example, a liquid crystal polyester used in applications of foods is preferably produced in the absence of a catalyst. It is necessary for the liquid crystal polyester produced using the catalyst to remove a catalyst component contained therein depending on applications in some cases.

The step (1) can be performed in an atmosphere of an inert gas such as nitrogen under the conditions of a normal or reduced pressure. It is particularly preferred that the step (1) is performed in an inert gas atmosphere under a normal pressure. The polycondensation is performed in a batch-wise or continuous manner or a combination thereof.

The polycondensation temperature of the step (1) is preferably from 260 to 350° C., and more preferably from 270 to 330° C. When the polycondensation temperature is lower than 260° C., the polycondensation proceeds slowly. In contrast, when the temperature is higher than 350° C., side reactions such as decomposition of the polymer are likely to occur. When the polymerization tank of the step (1) is composed of a division divided into multi-stages or partitioned plural divisions and the temperature of the polycondensation of each division is not the same, the highest temperature among them means the above polycondensation temperature.

The polymerization tank of the step (1) may be a polymerization tank having a known shape. In case of a vertical polymerization tank, the stirring blade is preferably a multi-stage paddle blade, a turbine blade, a monte blade or a double helical blade, and more preferably a multi-stage paddle blade or a turbine blade. A lateral polymerization tank is preferably a polymerization tank provided with a blade having a shape such as a lens blade, an eyeglass blade or an elliptical flat-plate blade in a vertical direction of a single or twin stirring shaft. In order to improve stirring performances and feed mechanism, the blade may be provided with torsion.

The polymerization tank is heated by a heat medium, a gas or an electric heater. In order to uniformly heat a reaction product in the polymerization tank, not only the polymerization tank, but also members to be immersed in the reaction product such as a stirring shaft, a blade and a baffle plate are preferably heated.

The prepolymer obtained in the step (1) preferably includes a repeating unit represented by the following formula (1) derived from a monomer (1′) (hereinafter referred to as a “repeating unit (1)”), and more preferably includes a repeating unit (1), a repeating unit represented by the following formula (2) derived from a monomer (2′) (hereinafter referred to as a “repeating unit (2)”) and a repeating unit represented by the following formula (3) derived from a monomer (3′) (hereinafter referred to as a “repeating unit (3)”).

—O—Ar¹—CO— (1)

—CO—Ar²—CO— (2)

—O—Ar³—O— (3)

The repeating unit (1) is preferably a repeating unit derived from p-hydroxybenzoic acid as a monomer (1′) in which Ar¹ is a p-phenylene group; or a repeating unit derived from 6-hydroxy-2-naphthoic acid as a monomer (1′) in which Ar¹ is a 2,6-naphthylene group.

The repeating unit (2) is preferably a repeating unit derived from terephthalic acid as a monomer (2′) in which Ar² is a p-phenylene group; a repeating unit derived from isophthalic acid as a monomer (2′) in which Ar² is a m-phenylene group; a repeating unit derived from 2,6-naphthalenedicarboxylic acid as a monomer (2′) in which Ar² is a 2,6-naphthylene group; or a repeating unit derived from diphenylether-4,4′-dicarboxylic acid as a monomer (2′) in which Ar² is a diphenylether-4,4′-diyl group.

The repeating unit (3) is preferably a repeating unit derived from hydroquinone as a monomer (3′) in which Ar³ is a p-phenylene group; or a repeating unit derived from 4,4′-dihydroxybiphenyl as a monomer (3′) in which Ar^{a} is a 4,4′-biphenylylene group.

In case of a liquid crystal polyester, the total amount of the repeating unit having a 2,6-naphthylene group is preferably 10 mol % or more, and more preferably 40 mol % or more, based on the total amount of the whole repeating unit. Namely, it is preferred that the prepolymer in the present invention is a prepolymer produced by melt polycondensation of a monomer represented by the above formula (1′), a monomer represented by the above formula (2′) and a monomer represented by the above formula (3′), and also the prepolymer is a prepolymer including 10 or more repeating units derived from a monomer having a 2,6-naphthylene group based on 100 units in total of the above repeating units (1), (2) and (3).

It is possible to exemplify, as the liquid crystal polyester having high heat resistance and melt tension, liquid crystal polyesters which satisfy the following conditions (I) to (V) (unless otherwise specified, the total amount of repeating units (1), (2) and (3) is 100 units):
(I) the content of a repeating unit (1) in which Ar¹ is a 2,6-naphthylene group is preferably from 40 to 74.8 units, more preferably from 40 to 64.5 units, and still more preferably from 50 to 58 units;
(II) the content of a repeating unit (2) in which Ar² is a 2,6-naphthylene group (hereinafter referred to as a “repeating unit (2A)”) is preferably from 12.5 to 30 units, more preferably from 17.5 to 30 units, and still more preferably from 20 to 25 units;
(III) the content of a repeating unit (2) in which Ar³ is a 1,4-phenylene group (hereinafter referred to as a “repeating unit (2B)”) is preferably from 0.2 to 15 units, more preferably from 0.5 to 12 units, and still more preferably from 2 to 10 units;
(IV) the amount of the repeating unit (2A) is preferably from 0 or more units, and more preferably 60 or more units, based on 100 units in total amount of the repeating units (2A) and (2B); and
(V) the content of a repeating unit (3) in which Ar^{a} is a 1,4-phenylene group is preferably from 12.5 to 30 units, more preferably from 17.5 to 30 units, and still more preferably from 20 to 25 units.

The flow initiation temperature of the prepolymer obtained in the step (1) is preferably 350° C. or lower, more preferably 160° C. or higher and 330° C. or lower, and still more preferably 170° C. or higher and 300° C. or lower from the viewpoint of easily discharging the prepolymer from the polymerization tank in a molten state. The flow initiation temperature can be adjusted by the conditions such as the temperature of melt polycondensation.

In the present invention, the flow initiation temperature is also called a flow temperature and means a temperature at which a melt viscosity becomes 4,800 Pa·s (48,000 poise) when a liquid crystal polyester is melted while heating at a heating rate of 4° C./rain under a load of 9.8 MPa (100 kg/cm²) and extruded through a nozzle having an inner diameter of 1 mm and a length of 10 mm using capillary rheometer, and the flow initiation temperature serves as an index indicating a molecular weight of the liquid crystal polyester (see “Liquid Crystalline Polymer Synthesis, Molding, and Application” edited by Naoyuki Koide, page 95, published by CMC on Jun. 5, 1987). The weigh average molecular weight of the prepolymer is preferably 10,000 or less, more preferably from 1,000 to 10,000, and still more preferably from 3,000 to 10,000, from the viewpoint of easily discharging the prepolymer from the polymerization tank in a molten state. The weigh average molecular weight having a correlation with the flow initiation temperature can also be adjusted by the conditions such as the temperature of melt polycondensation.

The discharge of the prepolymer in the step (2) is performed in an atmosphere of an inert gas such as a nitrogen gas or an atmosphere of air containing less moisture. From the viewpoint of obtaining a liquid crystal polyester having excellent color tone, the former atmosphere is preferable. The discharge is preferably performed in a state where the atmosphere in the polymerization tank is pressurized within a range from 0.1 to 2 kg/cm² G (gauge pressure), and more preferably from 0.2 to 1 kg/cm² G, using an inert gas such as nitrogen (atmospheric pressure is assumed to 1.033 kg/cm² A) . The discharge under pressure enables suppression of the formation of by-products and prevention of shift equilibrium of the polycondensation reaction to the side of the formation of the prepolymer, resulting in suppression of an increase in molecular weight of the prepolymer (that is, an increase in a flow temperature of a prepolymer).

Examples of the facility for the discharge of the prepolymer in a molten state include a known extruder, gear pump and valve. After discharging the prepolymer for a while, the prepolymer is solidified. Therefore, the prepolymer is formed into a sheet by solidification, for example, using the cooling apparatus 20 shown in FIG. 1.

In FIG. 1, the cooling device 20 is a double belt type cooler, and is a device in which an upper belt 21 and a lower belt 22 as endless belts are vertically disposed in close contact with each other, and a prepolymer is interposed between the upper belt 21 and the lower belt 22 and then solidified by cooling while transferring.

The upper belt 21 and lower belt 22 are belts made of metal, which have corrosion resistance such as a steel belt. The upper belt 21 and lower belt 22 are cooled by cooling water (not shown).

The upper belt 21 is wound between a first roller 23 and a second roller 24, and is provided in a tensioned state between these rollers. Similarly, the lower belt 22 is wound between a first roller 25 and a second roller 26, and is provided in a tensioned state between these rollers.

The prepolymer P produced by the polymerization device 10 is discharged on a top surface (denoted by the symbol A in the drawing) of the lower belt 22 in the cooling device 20. The upper belt 21 and lower belt 22 are transferred to the downstream side while interposing the prepolymer P therebetween by driving each roller. The prepolymer P is solidified by cooling while transferring in a state of being interposed in the cooling device 20. The length of the upper belt 21 and lower belt 22, and a transfer rate of the prepolymer P using the same are set according to the cooling target temperature of the prepolymer P.

The solidified prepolymer is formed into sheet-shaped solid substance PS shown in FIG. 2(A) by the cooling apparatus 20 of FIG. 1. The thickness of the sheet-shaped solid substance is controlled by adjusting the space between the upper belt 21 and the lower belt 22 of FIG. 1. In the step (2), a sheet in which the portion having a thickness of 1.6 to 2 mm accounts for 80% or more is produced. When the proportion of the portion having a thickness of less than 1.6 mm is too large, the prepolymer is formed into a fibril (fiber) shape by the crushing apparatus 30 of FIG. 1 and thus not only crushing properties drastically deteriorate by the following reason, but also the bulk density of the obtained crushed product decreases. When the thickness is more than 2 mm, cooling/solidification requires prolonged time, resulting in poor productivity of the liquid crystal polyester.

The prepolymer according to the present invention exhibits mesomorphism in a molten state. The surface portion of the prepolymer in a molten state is oriented and solidified, and the oriented and solidified layer is called a skin layer. The skin layer is likely to form a cross section along an orientation direction by crushing to obtain a fibril-shaped crushed product. In the portion where the solid substance has a thickness of less than 1.6 mm, since the proportion of the skin layer based on the entire solid substance increases, the fibril-shaped crushed product increases, and thus the bulk density decreases. Furthermore, the skin layer is less likely to be crushed since it is firm as compared with a layer in an amorphous state.

The thickness of the sheet-shaped solid substance PS of FIG. 2(A) is measured by (1) a method in which the thickness is measured with respect to a cut surface of typical several width directions intersected with a flow direction of the sheet (direction of a line segment A-A) and the entire sheet thickness is estimated from the obtained measured values, or (2) a method in which the thickness is measured with respect to the whole region of the sheet. The method (1) is applied in case the solid substance PS has high dimensional stability.

FIG. 2(B) is a sectional view taken along a line segment A-A of FIG. 2(A). In case of a sheet as shown in FIG. 2(B) in which the thickness of the sheet is not entirely uniform, it is assumed that (1) a sheet in which 80% or more in a width direction of the sheet shows a thickness of 1.6 to 2 mm even if the thickness W2 of the most thick portion is more than 2 mm, and (2) a sheet in which 80% or more in a width direction of the sheet shows a thickness of 1.6 to 2 mm even if the thickness W1 of the most thin portion is less than 1.6 mm satisfy “the portion having a thickness of 1.6 to 2 mm accounts for 80% by mass or more” in the present invention based on the below-mentioned reason.

Since a prepolymer P discharged from the polymerization apparatus 10 has almost uniform composition, a sheet-shaped solid substance PS has a given density regardless of the position. Therefore, it is considered that a sheet in which the portion having a thickness of 1.6 to 2 mm accounts for 80% or more of the entire sheet” can satisfies a “sheet in which the portion having a thickness of 1.6 to 2 mm accounts for 80% by mass or more” in the present invention from the viewpoint of a mass ratio.

A known method can be employed as the cooling and solidifying method in the step (2). Examples of the method include (1) a method in which cooling/solidification is performed by a double-belt cooler like the cooling apparatus 20 shown in FIG. 1, (2) a method in which cooling/solidification is performed by a single-belt cooler, (3) a method in which cooling/solidification is performed by a roll mill with plural grooves on a surface, and (4) a method in which cooling/solidification is performed by passing a portion of the prepolymer in a molten state discharged from the polymerization tank through the space between a pair of rotating cooling rolls while temporarily retaining the prepolymer in a recess formed by the cooling rolls having rotation axes which are mutually in parallel, and a pair of dams. These methods are performed in a flow of an inert gas such as a nitrogen gas, or air flow.

In the methods (1) to (4), an aspect of cooling while rolling a prepolymer by a belt or roll is preferred from the viewpoint of controlling the thickness of a solid substance PS. Among these methods, the method (1) is particularly preferable since a large amount of a prepolymer is efficiently cooled within a short time.

The sheet produced by cooling and solidifying by the cooling apparatus 20 of FIG. 1 is fed to the crushing apparatus 30. The crushing apparatus 30 includes a first crushing device 31 provided at the upstream side, a second crushing device 32 provided at the downstream side, and a cover 33 provided for prevention of scattering of a crushed product.

The first crushing device 31 and the second crushing device 32 are rotation bodies provided with innumerable bar-shaped, protrusion-shaped or hook-shaped crushing teeth in an axial direction and a circumferential direction of a cylindrical core material, and a sheet is crushed by rotating around the core material serving as a central axis.

Examples of the apparatus for crushing a sheet include, in addition to a pin crusher like the crushing apparatus 30 shown in FIG. 1, jaw crusher, a gyratory crusher, a cone crusher, a roll crusher, an impact crusher, a hammer crusher, a cutter mill, a rod mill, a ball mill, a jet-mill and a fan-type crusher.

Crushing may be performed in multi-stage process by using the crushing apparatus 30 of FIG. 1 in combination with one or two or more of other crushing apparatuses. Particularly, an aspect of sequentially crushing by a pin crusher, a cutter mill and a fan-type crusher is preferable.

From the viewpoint of ease of handling, the crushed product (particles) obtained by crushing preferably has d₅₀ of about 50 to 1,000 μm “d₅₀” means a particle size in which weight percentage obtained by a sieving test is 50%, and is referred to as an effective particle diameter or an average particle diameter. A sieving test method using a standard sieve is used as a method of measuring a diameter of particles.

The bulk density of the crushed product is preferably 0.3 g/cc or more, and more preferably from about 0.3 to 0.5 g/cc from the viewpoint of improving productivity of a liquid crystal polyester by increasing the amount of the crushed product to be treated in the step (3). The bulk density can be adjusted by setting the conditions of the cooling apparatus 20 so that the sheet in which the portion having a thickness of 1.6 to 2 mm accounts for 80% by mass or more is produced in the step (2). When the bulk density is less than 0.3 g/cc, the amount of the crushed product to be treated in the step (3) may decrease.

The crushed product is fed to a solid-phase polymerization facility (not shown) of FIG. 1, where the molecular weight is increased by solid-phase polymerization through heating under an inert gas atmosphere, and the unreacted raw material is removed to produce the objective liquid crystal polyester (step (3)).

The rate of temperature increase and maximum heating temperature of the solid-phase polymerization are set so that particles of the produced liquid crystal polyester are not welded with to each other. Welding is not preferable from the viewpoint of decreasing a surface area of the crushed product to be subjected to solid-phase polymerization, and thus decreasing a reaction rate of solid-phase polymerization and a rate of the removal of a low boiling point component. The rate of temperature increase is preferably from 0.05 to 1.00° C./minute, and more preferably from 0.05 to 0.20° C./minute. The maximum heating temperature is preferably from 200 to 400° C., and more preferably from 230 to 350° C. When the maximum heating temperature is lower than 200° C., the reaction rate of the solid-phase polymerization is low, resulting in lack of economy. In contrast, when the maximum heating temperature is higher than 350° C., welding may occur and it may be impossible to maintain a solid phase state due to melting. The time of solid-phase polymerization is preferably from 1 to 24 hours.

Examples of the device of the solid-phase polymerization include various known devices capable of heat-treating a powder such as a dryer, a reactor, a mixer and an electric furnace. Among these devices, a gas circulating device with high degree of sealing is preferable since solid-phase polymerization can be performed under an inert gas atmosphere.

The above-mentioned inert gas is preferably nitrogen, helium, argon or a carbon dioxide gas, and more preferably nitrogen. The flow rate of the inert gas is determined taking account of factors such as volume of the device of the solid-phase polymerization, and particle size and filling state of the crushed product, and is usually from 2 to 8 m³/hour, and preferably from 3 to 6 m³/hour, per 1 m³ of the device of the solid-phase polymerization. When the flow rate is less than 2 m³/hour, the rate of the solid-phase polymerization is low. In contrast, when the rate is more than 8 m³/hour, scattering of the crushed product may occur in some cases.

The liquid crystal polyester obtained by the production method of the present invention can be preferably granulated into the form of pellets after melting.

Examples of the method of granulating into pellets include a method in which a liquid crystal polyester is melt-kneaded using a commonly used single- or twin-screw extruder, air-cooled or water cooled and then formed into pellets using a pelletizer (strand cutter). Among commonly used extruders, an extruder with large L/D is preferable for forming after uniformly melting the liquid crystal polyester. The setting temperature (die head temperature) of a cylinder of the extruder is preferably from 200 to 420° C., more preferably from 230 to 400° C., and still more preferably from 240 to 380° C.

Inorganic fillers can be optionally added to the liquid crystal polyester produced by the production method of the present invention. Examples of inorganic fillers include calcium carbonate, talc, clay, silica, magnesium carbonate, barium sulfate, titanium oxide, alumina, montmorillonite, gypsum, glass flake, glass fiber, carbon fiber, alumina fiber, silica alumina fiber, aluminum borate whisker and potassium titanate fiber. These inorganic fillers can be used as long as transparency and mechanical strength of the molding such as a film made of the liquid crystal polyester are not drastically impaired.

It is also possible to optionally add various additives such as an organic filler, an antioxidant, a heat a stabilizer, a photostabilizer, a flame retardant, a lubricant, an antistatic agent, an inorganic or organic colorant, a rust preventing agent, a cross-linking agent, a blowing agent, a fluorescent agent, a surface smoothing agent, a surface gloss improver and a mold release improver (for example, fluororesin) to the liquid crystal polyester produced by the production method of the present invention during the production process of the liquid crystal polyester or processing process after the production.

### Production in Stable Manner

According to the present invention, it is possible to produce a liquid crystal polyester with high productivity in a stable manner by controlling bulk density of a crushed product used in solid-phase polymerization.

### EXAMPLES

While the present invention has been descried by way of Examples, the present invention is not limited to these Examples.

### Example 1

In a polymerization tank having a capacity of 200 L and an inner diameter of 600 mm, equipped with a stirrer, a nitrogen gas introduction device, a thermometer and a reflux condenser, 33.1 kg (0.322 kmol) of acetic anhydride was charged under a nitrogen atmosphere. Then, 27.9 kg (0.148 kmol) of 2-hydroxy-6-naphthoic acid, 7.4 kg (0.067 kmol) of hydroquinone, 2.2 kg (0.013 kmol) of terephthalic acid, 10.2 kg (0.047 kmol) of 2,6-naphthalenedicarboxylic acid, and 4.8 g of 1-methylimidazole as an acetylation catalyst were charged. Then, the temperature was raised to 140° C. under a nitrogen gas flow and the reaction mixture was refluxed at a temperature of 137° C. to 140° C. for 1 hour. While pressurizing the inside of the polymerization tank with nitrogen to 1 kg/cm², the reaction mixture was transferred to a 100 L polymerization vessel, and then the temperature was raised to 305° C. over 4 hours in the polymerization vessel while distilling off acetic acid and the unreacted acetic anhydride, and the reaction was carried out at 305° C. for 125 minutes to obtain a prepolymer.

The prepolymer was discharged into a NR type double-belt cooler manufactured by Nippon Belting Co., Ltd. from the polymerization vessel in a molten state, and then solidified with cooling while rolling by adjusting the space between belts of the double-belt cooler to obtain a sheet having an almost uniform thickness of 1.6 mm in the entire portion.

The sheet was coarsely divided using a pin crusher attached to the double-belt cooler at an average treating rate of 64.1 kg/hr and then coarsely crushed in a feed amount of 10 kg/hour using Feather Mill manufactured by Hosokawa Micron Corporation under the conditions screen pore diameter of 6 mm, a rotary speed of 2,020 rpm and a rotor diameter of 280 mm. The obtained coarse crushed product was finely crushed in a feed amount of 4 kg/hour using Bantum Mill manufactured by Hosokawa Micron Corporation under the conditions of a screen pore diameter of 2 mm, a rotary speed of 7,000 rpm, a rotor diameter of 140 mm and a peripheral speed of 51.3 m/s to obtain a powdered crushed product having bulk density of 0.31 g/cc.

The thickness of the sheet was determined by measuring each thickness at 5 positions in total, for example, 2 positions at both ends of the sheet in a width direction and 3 positions which divide the distance therebetween into quarters, using a micrometer manufactured by Mitutoyo Corporation, and then calculating an average of those measured values.

The bulk density was measured by using a powder tester PT-E manufactured by Hosokawa Micron Corporation, which is a powder characteristic total measurement apparatus.

### Example 2

The space between belts of the double-belt cooler of Example 1 was adjusted to obtain a sheet having an almost uniform thickness of 2.0 mm in the entire portion, and this sheet was crushed in the same manner as in Example 1 to obtain a powdered crushed product having bulk density of 0.41 g/cc.

### Example 3

The crushed product (80% by mass) obtained in Example 1 was mixed with a crushed product (20% by mass), which was obtained by crushing a sheet having an almost uniform thickness of 2.2 mm in the entire portion obtained by adjusting the space between belts of the double-belt cooler of Example 1, in the same manner as in Example 1, using a super mixer to obtain a powdered crushed product having bulk density of 0.30 g/cc.

### Example 4

The crushed product (80% by mass) obtained in Example 2 was mixed with a crushed product (20% by mass), which was obtained by crushing a sheet having an almost uniform thickness of 2.2 mm in the entire portion obtained by adjusting the space between belts of the double-belt cooler of Example 1, in the same manner as in Example 1, using a super mixer to obtain a powdered crushed product having bulk density of 0.41 g/cc.

### Comparative Example 1

A crushed product (80% by mass), which was obtained by crushing a sheet having an almost uniform thickness of 1.0 mm in the entire portion obtained by adjusting the space between belts of the double-belt cooler of Example 1, in the same manner as in Example 1, was mixed with a crushed product (20% by mass), which was obtained by crushing a sheet having an almost uniform thickness of 2.2 mm in the entire portion obtained by adjusting the space between belts of the double-belt cooler of Example 1, in the same manner as in Example 1, using a super mixer to obtain a powdered crushed product having bulk density of 0.16 g/cc.

### Comparative Example 2

The crushed product (40% by mass) obtained in Example 2 was mixed with a crushed product (60% by mass), which was obtained by crushing a sheet having an almost uniform thickness of 2.2 mm in the entire portion obtained by adjusting the space between belts of the double-belt cooler of Example 1, in the same manner as in Example 1, using a super mixer to obtain a powdered crushed product having bulk density of 0.20 g/cc.

Based on the above test data, it was confirmed that a crushed product, which contains 80% by mass or more of a crushed product derived from a sheet having a thickness of 1.6 to 2 mm, has bulk density of 0.3 g/cc or more, namely, bulk density which is capable of improving productivity of a liquid crystal polyester by increasing the amount of the crushed product to be treated in the step (3).

What is claimed is:

1. A method for producing a liquid crystal polyester, comprising the steps of:
(1) melt-polycondensing a compound as a monomer in a polymerization tank to produce a prepolymer;
(2) discharging the prepolymer from the polymerization tank in a molten state, and solidifying the prepolymer through cooling to produce a sheet in which a portion having a thickness of 1.6 to 2 mm accounts for 80% by mass or more (of 100% by mass of the entire sheet);
(3) crushing the sheet; and
(4) subjecting the crushed product to solid-phase polymerization through heating.

2. The method according to claim 1, wherein the prepolymer is a prepolymer produced by melt-polycondensing a monomer represented by the following formula (1′), a monomer represented by the following formula (2′) and a monomer represented by the following formula (3′), and also the prepolymer includes 10 or more repeating units derived from a monomer having a 2,6-naphthylene group based on 100 units in total of repeating units represented by the following formulas (1) to (3) derived from the respective formulas (1′) to (3′):
G-O—Ar¹—CO-G², (1′)
G¹-CO—Ar²—CO-G², (2′)
G¹-O—Ar³—O-G¹, (3′)
—O—Ar¹—CO—, (1)
—CO—Ar²—CO—, and (2)
—O—Ar³—O— (3)
wherein Ar¹ is a 2,6-naphthylene group, a 1,4-phenylene group or a 4,4′-biphenylylene group; Ar² and Ar³ each independently represents a 2,6-naphthylene group, a 1,4-phenylene group, a 1,3-phenylene group or a 4,4′-biphenylylene group; three G¹(s) each independently represents a hydrogen atom or an alkylcarbonyl group; three G²(s) each independently represents a hydroxyl group, an alkoxy group, an aryloxy group, an alkylcarbonyloxy group or a halogen atom; and one or more hydrogen atoms of Ar¹, Ar² and Ar³ each independently may be substituted with a halogen atom, an alkyl group or an aryl group.

3. The method according to claim 2, wherein the prepolymer include 40 or more repeating units derived from a monomer having a 2,6-naphthylene group based on 100 units in total of repeating units represented by the following formulas (1) to (3) derived from the respective formulas (1′) to (3′).

4. The method according to claim 2, wherein a monomer of the formula (1′) in which G1 is a hydrogen and/or a monomer of the formula (3′) in which G1 is a hydrogen atom is/are acylated before melt polycondensation of the step (1).
